(19) United States
(12) Patent Application Publication
(10) Pub. No.: US 2011/0215981 A1
(43) Pub. Date: Sep. 8, 2011

(54) HIGH FREQUENCY TRANSMISSION MODULE WITH IMPROVED HARMONIC FEATURE

(75) Inventors: Sang Hee KIM, Hwaseong (KR); Seong Geun KIM, Hwaseong (KR); Jae Hyouck CHOI, Seongnam (KR); Sang Wook PARK, Suwon (KR); Youn Suk KIM, Yongin (KR); Chul Hwan YOON, Suwon (KR)

(73) Assignee: SAMSUNG ELECTRO-MECHANICS CO., LTD., Suwon (KR)

(21) Appl. No.: 13/036,601

(22) Filed: Feb. 28, 2011

(30) Foreign Application Priority Data
Mar. 3, 2010 (KR) 10-2010-0019050

(51) Int. Cl. H01Q 1/50

(52) U.S. Cl. 343/852

(57) ABSTRACT

There is provided a high frequency transmission module, including: a high band power amplifier amplifying power of a preset high band frequency signal; a low band power amplifier amplifying power of a preset low band frequency signal; an LC matching circuit unit matching output impedance of the low band power amplifier to impedance of an antenna switch circuit; the antenna switch circuit connecting one of a first terminal connected to an output terminal of the high band power amplifier and a second terminal connected to the LC matching circuit unit to a common terminal; and a matching/ESD protecting unit matching impedances between the antenna switch circuit and an antenna and blocking static electricity introduced from the antenna.

### CROSS-REFERENCE TO RELATED APPLICATIONS

This application claims the priority of Korean Patent Application No. 10-2010-0019050 filed on Mar. 3, 2010, in the Korean Intellectual Property Office, the disclosure of which is incorporated herein by reference.

### BACKGROUND OF THE INVENTION

1. Field of the Invention

The present invention relates to a high frequency transmission module capable of being applied to a mobile device, and more particularly, to a high frequency transmission module with an improved harmonic feature capable of reducing the generation of harmonic distortion by disposing a matching circuit at a rear end of an antenna switch to reduce voltage applied to a switching transistor.

2. Description of the Related Art

Generally, a high frequency transmission module according to the related art has been configured of a high-band power amplifier, a low-band power amplifier, matching circuits for each band, an antenna switch circuit, and an electrostatic discharge (ESD) protection circuit.

The high frequency transmission module according to the related art has included an LC matching circuit changing a load resistance from 50 ohms to 5 ohms in order to generate a large amount of power in a power transistor of the power amplifier. An LC circuit in radio frequency (RF) serves as a transformer in a low frequency circuit. Accordingly, voltage is boosted by being passed through the LC matching circuit, and the boosted voltage passes through a switching transistor of the antenna switch circuit.

In addition, the high frequency transmission module according to the related art has used an antenna switch module (ASM) in order to reduce interference between a transmitting end and a receiving end, and has the electrostatic discharge (ESD) protection circuit using a lumped element having a relatively large value and added to a rear end of the antenna switch circuit in order to protect from electrostatic discharge (ESD) of about 8 KV, the ASM being implemented by the switching transistor using a metal semiconductor field effect transistor (MESFET) or a complementary metal oxide semiconductor (CMOS).

However, the high frequency transmission module has two problems according to the related art.

First, when high voltage is applied to a switching transistor included in the antenna switch circuit, the high voltage may be distorted due to non-linearity within the switching transistor of the antenna switch circuit thereby causing harmonic distortion.

Second, since the electrostatic discharge (ESD) protection circuit should use a capacitor having high capacitance in order to protect from electrostatic discharge, additional loss has been caused due to the high capacitance therein.

Furthermore, as described above, the electrostatic discharge protection circuit'has caused additional insertion loss due to the lumped element having the large value, particularly, inductance value.

### SUMMARY OF THE INVENTION

An aspect of the present invention provides a high frequency transmission module with an improved harmonic feature capable of reducing generation of a harmonic distortion by disposing a matching circuit at a rear end of an antenna switch to reduce voltage applied to a switching transistor.

According to an aspect of the present invention, there is provided a high frequency transmission module, including: a high band power amplifier amplifying power of a preset high band frequency signal; a low band power amplifier amplifying power of a preset low band frequency signal; an LC matching circuit unit matching output impedance of the low band power amplifier to impedance of an antenna switch circuit; the antenna switch circuit connecting one of a first terminal connected to an output terminal of the high band power amplifier and a second terminal connected to the LC matching circuit unit to a common terminal; and a matching/ESD protecting unit matching impedances between the antenna switch circuit and an antenna and blocking static electricity introduced from the antenna.

The LC matching circuit unit may include: an inductor having one end connected to an output terminal of the low band power amplifier and the other end connected to the second terminal of the antenna switch circuit; and a capacitor connected between the other end of the inductor and a ground.

The matching/ESD protecting unit may include: a matching circuit unit including a plurality of inductors and a plurality of capacitors to match the impedances between the antenna switch circuit and the antenna; and an ESD protecting circuit unit blocking the static electricity introduced from the antenna, one of the plurality of capacitors included in the matching circuit unit being a common capacitor included in the ESD protecting circuit unit for electrostatic discharge protection of the ESD protecting circuit unit.

The common capacitor of the matching/ESD protecting unit may be set to have an inductance value capable of reducing insertion loss.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a high frequency transmission module according to an exemplary embodiment of the present invention;

FIG. 2 is a circuit diagram of an LC matching circuit unit according to an exemplary embodiment of the present invention; and

FIG. 3 is a circuit diagram of a matching/ESD protecting unit according to an exemplary embodiment of the present invention.

### DETAILED DESCRIPTION OF THE PREFERRED EMBODIMENT

Exemplary embodiments of the present invention will now be described in detail with reference to the accompanying drawings.

The present invention should not be limited to the embodiments set forth herein and the embodiments may be used to assist in understanding the technical idea of the present invention. Like reference numerals designate like components having substantially the same constitution and function in the drawings of the present invention.

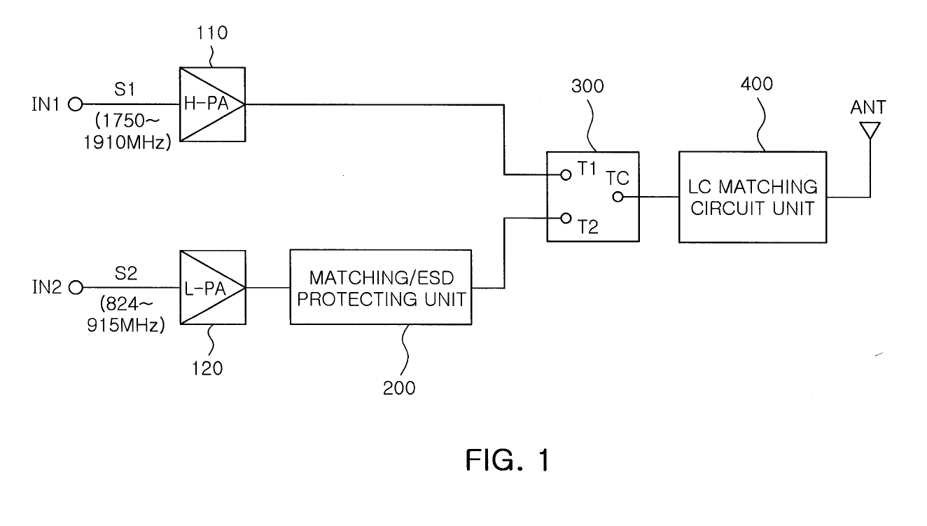

FIG. 1 is a block diagram of a high frequency transmission module according to an exemplary embodiment of the present invention.

Referring to FIG. 1, a high frequency transmission module according to an exemplary embodiment of the present invention may include a high band power amplifier 110 amplifying power of a preset high band frequency signal, a low band power amplifier 120 amplifying power of a preset low band frequency signal, an LC matching circuit unit 200 matching output impedance of the low band power amplifier 120 to impedance of an antenna switch circuit 300, an antenna switch circuit 300 connecting anyone of a first terminal T1 connected to an output terminal of the high band power amplifier 110 and a second terminal T2 connected to the LC matching circuit unit 200 to a common terminal TC, and a matching/ESD protecting unit 400 matching impedances between the antenna switch circuit 300 and an antenna ANT and blocking static electricity introduced from the antenna ANT.

At this time, the high band frequency signal may correspond to a signal having a frequency band of between, for example, 1750 and 1910 MHz, and the low band frequency signal corresponds to a signal having a frequency band of between, for example, 824 and 915 MHz.

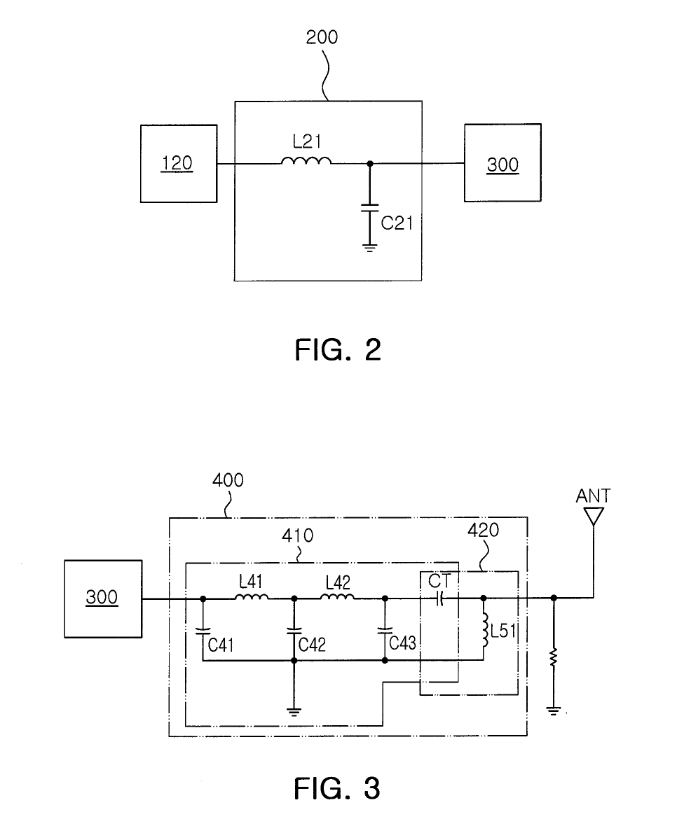

FIG. 2 is a circuit diagram of an LC matching circuit unit according to an exemplary embodiment of the present invention.

Referring to FIG. 2, the LC matching circuit unit 200 may include an inductor L21 having one end connected to an output terminal of the low band power amplifier 120 and the other end connected to the second terminal T2 of the antenna switch circuit 300, and a capacitor C21 between the other end of the inductor L21 and a ground.

FIG. 3 is a circuit diagram of a matching/ESD protecting unit according to an exemplary embodiment of the present invention.

Referring to FIG. 3, the matching/ESD protecting unit 400 may include a matching circuit unit 410 including a plurality of inductors and a plurality of capacitors to match impedances between the antenna switch circuit 300 and the antenna ANT, and an ESD protecting circuit unit 420 blocking static electricity introduced from the antenna ANT.

At this time, one CT of the plurality of capacitors included in the matching circuit unit 410 is a common capacitor included in the ESD protecting circuit unit 420 for electrostatic discharge protection of the ESD protecting circuit unit 420.

Here, the common capacitor CT of the matching/ESD protecting unit 400 may be set to have an inductance value capable of reducing insertion loss.

Hereinafter, the operations and effects of the present invention will be described in detail with reference to the accompanying drawings.

The high frequency transmission module according to an exemplary embodiment of the present invention may be applied to mobile terminals such cellular phones. Describing the high frequency transmission module according to an exemplary embodiment of the present invention with reference to FIGS. 1 to 3, in FIG. 1, the high band power amplifier 110 of the high frequency transmission module according to the exemplary embodiment of the present invention may amplify power of the preset high band frequency signal to transfer the amplified power to the first terminal T1 of the antenna switch circuit 300.

The low band power amplifier 120 according to the exemplary embodiment of the present invention may amplify power of the preset low band frequency signal to transfer the amplified power to the LC matching circuit unit 200.

At this time, the high band frequency signal may have the band of, for example, 1750 to 1910 MHz, and may correspond to a signal having a GSM (global system for mobile communications) 1800 band, a personal communications system (PCS) band, or a DCS 1800 band. In addition, the low band frequency signal may have a frequency band of, for example, 824 to 915 MHz, and may correspond to a signal having a GSM 900 (EGSM) band.

The LC matching circuit unit 200 matches output impedance of the low band power amplifier 120 to impedance of the antenna switch circuit 300, such that a signal from the low band power amplifier 120 is transferred to the second terminal T2 of the antenna switch circuit 300 without a loss of signal.

The LC matching circuit unit 20 may be actually made of including the inductor L21 and the capacitor C21 as in a low pass filter, as shown in FIG. 2.

Meanwhile, according to a service provided in an area in which mobile terminals applied with the high frequency transmission module according to an exemplary embodiment of the present invention are used, the high band or the low band may be selected in the mobile terminal.

Accordingly, in a mobile terminal having the high frequency transmission module according to an exemplary embodiment of the present invention applied thereto, when the high band is selected, the antenna switch circuit 300 according to an exemplary embodiment of the present invention connects the first terminal T1 to the common terminal TC. Therefore, the signal from the high band power amplifier 110 is transferred to the matching/ESD protecting unit 400.

On the other hand, when the low band is selected, the antenna switch circuit 300 according to an exemplary embodiment of the present invention may connect the second terminal T2 to the common terminal TC. Therefore, the signal from the low band power amplifier 120 through the LC matching circuit unit 200 is transferred to the matching/ESD protecting unit 400.

The matching/ESD protecting unit 400 may match the impedances between the antenna switch circuit 300 and the antenna ANT, whereby the signal from the antenna switch circuit 300 may be transferred to the antenna (ANT) without loss.

In addition, the matching/ESD protecting unit 400 may block the static electricity introduced from the antenna ANT.

Describing the matching/ESD protecting unit 400 with reference to FIG. 3, the matching/ESD protecting unit 400 may be configured of the matching circuit unit 410 including the plurality of inductors and the plurality of capacitors, and the ESD protecting circuit unit 420.

At this time, the matching circuit unit 410 may match impedances between the antenna switch circuit 300 and the antenna ANT, whereby the signal from the antenna switch circuit 300 may be transferred to the antenna ANT without loss, as described above.

In addition, the ESD protecting circuit unit 420 may block the static electricity introduced from the antenna ANT.

Particularly, one CT of the plurality of capacitors included in the matching circuit unit 410 may be also included as the common capacitor in the ESD protecting circuit unit 420 for electrostatic discharge protection of the ESD protecting circuit unit 420. When the common capacitor is implemented as described above, the number of used elements may be reduced.

Furthermore, the common capacitor CT of the matching/ESD protecting unit 400 may be set to have a relatively low inductance value. In this case, the insertion loss may be reduced.

As set forth above, according to the exemplary embodiments of the present invention, the matching circuit is disposed at the rear end of the antenna switch to reduce the voltage applied to the switching transistor, thereby reducing the generation of the harmonic distortion. In addition, since the matching circuit may simultaneously perform both of an impedance matching function and an ESD protection function, a relatively low value of inductance (10 nH or less) rather than a high value of inductance (generally 56 nH) may be used in order to protect the ESD of 8 KV, whereby the additional insertion loss may be reduced.

While the present invention has been shown and described in connection with the exemplary embodiments, it will be apparent to those skilled in the art that modifications and variations can be made without departing from the spirit and scope of the invention as defined by the appended claims.

What is claimed is:

1. A high frequency transmission module, comprising:
a high band power amplifier amplifying power of a preset high band frequency signal;
a low band power amplifier amplifying power of a preset low band frequency signal;
an LC matching circuit unit matching output impedance of the low band power amplifier;
an antenna switch circuit connecting one of a first terminal connected to an output terminal of the high band power amplifier and a second terminal connected to the LC matching circuit unit to a common terminal; and
a matching/ESD protecting unit matching impedances between the antenna switch circuit and an antenna and blocking static electricity introduced from the antenna.

2. The high frequency transmission module of claim 1, wherein the LC matching circuit unit includes:
an inductor having one end connected to an output terminal of the low band power amplifier and the other end connected to the second terminal of the antenna switch circuit; and
a capacitor connected between the other end of the inductor and a ground.

3. The high frequency transmission module of claim 1, wherein the matching/ESD protecting unit includes:
a matching circuit unit including a plurality of inductors and a plurality of capacitors to match the impedances between the antenna switch circuit and the antenna; and
an ESD protecting circuit unit blocking the static electricity introduced from the antenna,
one of the plurality of capacitors included in the matching circuit unit being a common capacitor included in the ESD protecting circuit unit for electrostatic discharge protection of the ESD protecting circuit unit.

4. The high frequency transmission module of claim 1, wherein the common capacitor of the matching/ESD protecting unit is set to have an inductance value capable of reducing insertion loss.
